(19) United States
(12) Patent Application Publication
(10) Pub. No.: US 2026/0037288 A1
(43) Pub. Date: Feb. 5, 2026

(54) TECHNIQUES FOR EXECUTING COMMANDS AND SCRIPTS ACROSS OPERATING SYSTEMS

(71) Applicant: WELLS FARGO BANK, N.A., San Francisco, CA (US)

(72) Inventors: Niraj Pandey, Edison, NJ (US); Sri krishna Uppili, Chennai (IN); Dmitry Sukner, Brooklyn, NY (US)

(21) Appl. No.: 18/792,047

(22) Filed: Aug. 1, 2024

(51) Int. Cl. G06F 9/455; G06F 11/32

(52) U.S. Cl. CPC G06F 9/45512; G06F 11/327; G06F 2201/835

(57) ABSTRACT

Systems and methods for executing commands and scripts across operating systems and gathering results in a unified manner are provided. A method includes receiving one or more commands from a predefined list of commands from one or more devices in a distributed computing environment; receiving a set of targets distributed in the distributed computing environment; translating the one or more commands to a set of target commands, wherein each target command is associated with at least one target of the set of targets; transmitting a request to execute a script associated with each of the target commands to each of the targets; executing the script on each of the targets thereby generating a plurality of results corresponding to each of the target commands and each of the targets; and storing the plurality of results in a format for display in a user interface.

### TECHNICAL FIELD

Embodiments of the present disclosure generally relate to data processing, and more particularly to improved techniques for executing commands and scripts across a distributed computing network and organizing and displaying results in a unified manner.

### BACKGROUND

In a distributed computing network, routine maintenance and monitoring of computing systems is important for an enterprise to efficiently identify and remediate problems that arise at various computing systems distributed across the computing network. Maintenance and monitoring of computing systems in a distributed computing network is often performed on an individualized basis thereby producing scattered and disorganized results. This also creates inefficiencies, where computing resources and human resources are dedicated to performing these manually intensive tasks. Current tools lack the ability to execute commands across various computing systems in a distributed computing network and organize the results in an efficient and unified manner.

### SUMMARY

Certain aspects and features of the present disclosure generally relate to data processing. More specifically and without limitation, techniques disclosed herein relate to improved techniques for executing commands and scripts across a distributed computing network and organizing and displaying results in a unified manner. According to an aspect of the present disclosure, a method includes: receiving one or more commands from a predefined list of commands from one or more devices in a distributed computing environment; receiving a set of targets distributed in the distributed computing environment; translating the one or more commands to a set of target commands, wherein each target command is associated with at least one target of the set of targets; transmitting a request to execute a script associated with each of the target commands to each of the targets; executing the script on each of the targets thereby generating a plurality of results corresponding to each of the target commands and each of the targets; and storing the plurality of results in a format for display in a user interface.

In a further aspect, further example methods may include a first target having a first operating system and a second target having a second operating system that is different from the first operating system. Additionally, the script associated with each of the target commands comprises a first script operable to execute the target command on the first target and a second script operable to execute the target command on the second target.

In another aspect, further example methods may include: transmitting a timestamp to the set of target commands executed on the each of the targets; receiving an indication of a failure at one or more of the targets during execution of the script; generating, in response to receiving an indication of the failure, an alert of the failure for display on the user interface; modifying, in response to receiving the alert, the script associated with the target command thereby generating a modified script; transmitting a second request to one or more of the targets to execute the modified script; and executing the modified script on the one or more targets. In some aspects, the failure may be detected when a time for executing the script exceeds a predefined threshold as compared to the timestamp.

According to another aspect, the format for display may include a table comprising a plurality of rows and each row displays one of the results of the plurality of results and wherein each row corresponds to a particular target. In another aspect, the plurality of results may include at least one of a determination of a software version implemented on a target, a list of processes running on a target, a list software programs installed on a target, a determination of a top consuming computing resource on a target, a memory capacity of a target, a list of program data located in a folder of a target, and a determination of whether a particular configuration file is used across the set of targets.

The above methods can be implemented as computer-executable program instructions stored in a non-transitory, tangible computer-readable medium or media and/or operating within a system including one or more processors or other processing device and memory. For example, the above methods may be implemented in a cloud service executed on cloud service provider infrastructure, which may include various servers, processors, and databases.

Numerous benefits are achieved by way of the various embodiments over conventional techniques. For example, examples of the present disclosure provide systems and methods for executing commands and scripts across a distributed computing network and organizing and displaying results in a unified manner which enables the ability to query hundreds or thousands of computing systems based on one or more selected commands. The techniques described herein also enable the ability to gather the generated output in an organized and unified manner.

As one example, techniques described by the present disclosure can include executing a versioning command across targets in a distributed computing network to determine the version of installed software across all hosts. The techniques described by the present disclosure allow a user of any expertise level (e.g., by virtue of the predefined commands) to execute the commands that have the appropriate arguments, options, and flags predefined. Additionally, the techniques consolidate the results in a unified manner thereby enabling analytics in minutes. The techniques described by the present disclosure thus level the playing field for users of all expertise levels and significantly reduce the time to perform routine maintenance and monitoring of computing systems, which would have been manually intensive and/or impossible using prior techniques (e.g., manually querying hundreds or thousands of individual targets).

Additionally, the techniques described by the present disclosure provide for dynamic recommendations to assist a user in selecting the appropriate commands. The techniques provide an intuitive user interface where commands can be selected and filled out with the proper parameters through the help of a recommender engine. The recommender engine can provide suggestions based on prior executions. The recommender engine can also provide helpful hints and descriptions if a command is being executed for the first time. The techniques provided herein thus provide for a self-learning aspect by populating a predefined list of all commands pre-filled with correct arguments, options and flags that is continually updated based on user interaction. The predefined list is created, and users can search the commands based on their need and execute them along with providing the list of targets. Users can also group commands and execute them together thereby enabling a user to execute multiple commands across hundreds of targets, gather results, and conduct analytics more efficiently.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example computing environment for executing commands across a distributed computing network, according to one or more aspects of the present disclosure;

FIG. 2 is a block diagram illustration of an example application user interface and sample command, according to one or more aspects of the present disclosure;

FIG. 3 is a block diagram illustrating an example application user interface displaying a generated output, according to one or more aspects of the present disclosure;

FIG. 4 is a block diagram illustrating an example of an application user interface and sample template, according to one or more aspects of the present disclosure;

FIG. 5 is a block diagram illustrating an example of an application user interface and activity panel, according to one or more aspects of the present disclosure;

FIG. 6 is a flowchart of an example of a process for executing commands and scripts across operating systems, according to one or more aspects of the present disclosure;

FIG. 7 is a block diagram illustrating an example computer-readable medium or computer-readable device including processor-executable instructions configured to embody one or more aspects of the present disclosure; and

FIG. 8 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

The present disclosure describes techniques for executing commands and scripts against computing systems. Computing systems may refer to physical servers or remote servers, containers (e.g., a Docker container), or container orchestration platforms (e.g., Kubernetes). Thus, the term computing system includes any kind of server, any kind of underlying operating system, any kind of cloud provider, and multiple different container types. For the sake of simplicity, the systems and steps described below are described in relation to executing commands and scripts on “targets,” where targets refers to a particular type of computing system. One of ordinary skill in the art would recognize many variations, modifications, and alternatives.

In an enterprise setting, there are instances where it may be necessary to execute specific commands across multiple targets (e.g., remote or physical servers, operating systems, cloud providers, containers, container orchestration platforms, or other types of computing systems) in a distributed computing network. In one illustrative embodiment, a system for executing commands and scripts across a distributed computing network and organizing and displaying results in a unified manner includes a computing device hosting a command executor module. The computing device is coupled to a user device that displays an application user interface that enables interaction by a user with the command executor module. A user provides an input to the application user interface, where the input is associated with one or more commands selected from a predefined list of commands or command templates that may be edited by the user. For the one or more commands selected by the user, the user can provide a list of targets to execute the command on, where the targets are distributed across a distributed computing network. After providing the input, the command executor module receives the input and sends a request to each target specified by the user. Transmission of the request initiates execution of a script on the target where the script executes the specified command. Execution of the script generates an output based on the selected command. The generated output is returned to the command executor module. Each generated output may be organized with the generated output from each target and displayed in a unified manner (e.g., in a table, chart, graph, etc.) on the application user interface.

The generated output includes results from the one or more targets based on the one or more selected commands. This unified output enables a user to quickly select from a predefined list of commands with the arguments, flags, and options prefilled and/or adjustable based on the user needs. The user can then specify the targets of interest from a predefined list of available targets within the distributed computing network. Upon execution, the command executor module can simultaneously execute the commands across all selected targets in the distributed computing network and gather all the generated outputs for analytics purposes.

As described above, in an enterprise setting, an enterprise can control hundreds or even thousands of computing systems across a distributed computing network. Each computing system, which may be a physical or remote server, a container, a container orchestration platform, etc., in the distributed network can host applications, store data, etc. that can be used or otherwise accessed by users of the distributed computing network. Information technology specialists of the enterprise may be tasked with performing routine maintenance and monitoring of all the computing systems in the distributed computing network. This can include, for example, determining a version of a software program running on each computing system, identifying vulnerabilities within the computing systems (e.g., fraud, spam, data breach attacks, etc.), determining whether the application log files for each computing system are properly being transmitted to a central computing system for analysis on a regular and/or periodic basis, etc. As part of this routine maintenance and monitoring of all the computing systems, specialists must be able to run commands simultaneously across multiple computing systems (e.g., rather than individually accessing each computing system), and the commands must be agnostic to the particularities of the computing system (e.g., the type of server, the underlying operating system of the computing system, the type of cloud provider, the type of container). Otherwise, performing the routine maintenance and monitoring would be incredibly time consuming and computationally and labor intensive. For example, in the case where a vulnerability on one computing system is identified, the techniques described herein provide an efficient and accurate mechanism to determine how widespread the vulnerability is in the distributed computing network. Without these techniques, executing a particular command on hundreds or thousands of computing systems in the distributed network could require days, weeks, or even months. This time delay in identifying vulnerabilities, for example, can have negative consequences in the enterprise setting where time is of the essence to get computing systems up and running.

Moreover, examples of the present disclosure provide for techniques to unify the generated outputs. For example, when a command is executed across hundreds or thousands of targets, the generated output can comprise hundreds or thousands of lines of data. The generated output is too vast for a human to quickly interpret and organize. Examples of the present disclosure provide for a command executor module that collects the generated outputs and logs the results in a unified manner (in a table, chart, graph, etc.) for display on an application user interface. Thus, examples of the present disclosure merge all generated outputs into a single unified display that may also be available for download by a user for further analytical purposes.

Techniques of the present disclosure also provide for a degree of user interaction with the command executor module. For example, the application user interface can include a search engine that a user can query. The search engine can provide suggestions to the user about which type of commands to select and which targets to execute the commands on to best achieve the goal of the user. This aspect of the present disclosure can level the playing field for users of varying expertise levels as the command executor module can provide suggestions or otherwise guide a user through using the module. The recommendations or suggestions provided by techniques of the present disclosure thus improve upon the technical field by saving computation resources. In other words, rather than have a user struggle through formatting commands appropriately (e.g., correctly defining all the arguments of the command) or searching other resources (e.g., searching the web for help), the user can interact directly with the command executor module and be provided assistance in how to effectively use it.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

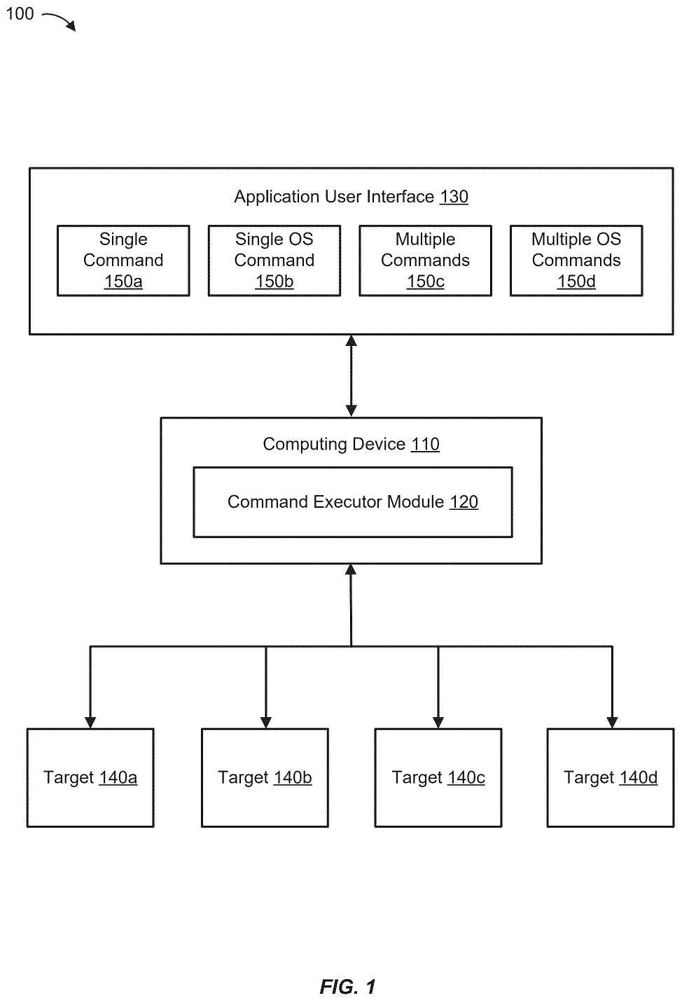

FIG. 1 is a block diagram illustrating an example computing environment 100 for executing commands across a distributed computing network, according to one or more aspects of the present disclosure. As shown in FIG. 1, the computing environment 100 for executing commands across a distributed computing network includes an application user interface 130 communicatively coupled (e.g., wired or wirelessly) to a computing device 110. The computing device 110 can host a command executor module 120 usable to perform the operations described herein. Application user interface 130 can include a variety of predefined commands selectable by a user interacting with the application user interface 130. For example, application user interface 130 can include single command 150a, single operating system (OS) command 150b, multiple commands 150c, and multiple OS commands 150d.

The computing environment 100 of FIG. 1 also includes multiple targets that are communicatively coupled (e.g., wired or wirelessly) with computing device 110. Target 140a, target 140b, target 140c, and target 140d can refer to the various computing systems distributed across a distributed computing network. In some instances, targets 140a-140d are selected by a user interacting with application user interface 130 to accomplish a certain task as defined by the selected command. In other instances, targets 140a-140d can refer to other forms of computing systems such as containers, cloud service providers, etc. A user may select a single command (e.g., single command 150a) or in some cases multiple commands (e.g., multiple commands 150c) in combination with a list of provided targets (e.g., targets 140a-140d). Additionally, although only four targets are shown in FIG. 1, any number of targets are possible. For example, in an enterprise setting, an enterprise may control hundreds or thousands of computing systems across a distributed computing network. Thus, one of ordinary skill will recognize that the number of targets illustrated in FIG. 1 is for simplicity in understanding the present disclosure.

Furthermore, although only four predefined commands are illustrated in FIG. 1, any number of predefined commands can be accessible by a user on the application user interface 130, and the predefined commands can be agnostic to the underlying operating system which they are executed on. For example, if a user selects single command 150a, single command 150a can be executed on multiple target as selected by the user. In the case where different operating systems are running on the multiple targets, the command executor module 120 is able to automatically adjust the script associated with the command depending on the operating system. As such, the user need not be concerned with properly configuring the command based on the underlying operating system. Instead, the user can focus on the high-level task they are trying to accomplish with the command. As described throughout the present disclosure, the commands included in the application user interface 130 can include a variety of different commands associated with routine maintenance and monitoring of computing systems distributed in a distributed computing network. Routine maintenance and monitoring can involve storage maintenance, root cause analysis of identified vulnerabilities, remediation of identified issues, and the like. One of ordinary skill in the art would recognize many variations, modifications, and alternatives.

After the one or more commands and the one or more targets are selected, the selected commands are passed to the command executor module 120, which runs in the background of the application user interface 130. The command executor module 120 executes the one or more commands with separate payloads across each selected target. The command executor module 120 then gathers the generate output from each target and merges the results together. In this way, the command executor module 120 scatters the command across all targets of interest and gathers the generated outputs, organizes the generated outputs, and displays the generated outputs back to the application user interface 130.

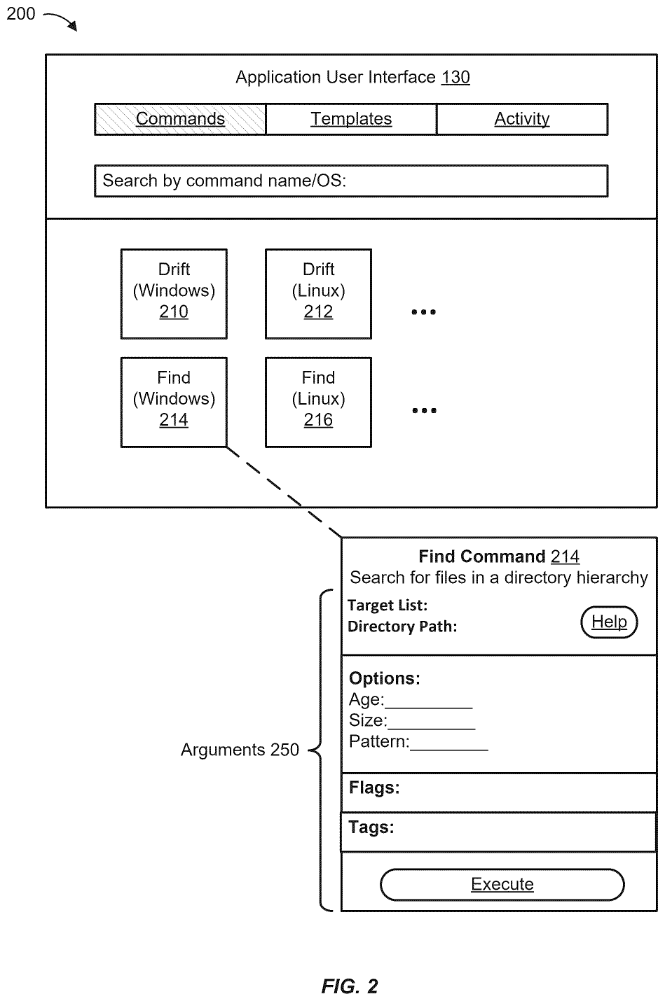

In one particular example, single command 150a could represent a “find” command that enables a user to search for files in a directory. The user can select the predefined find command (e.g., command 150a) to execute along with a list of target to execute the command on (e.g., targets 140a-140d). Additionally, and as further described in relation to FIGS. 2-5, depending on the particular context and need of the user, the user can modify single command 150a by adjusting a variety of arguments associated with single command 150a.

Continuing on with the example of the “find” command, after the user selects the targets 140a-140d, the user can execute the command. The command is received by the computing device 110, where a processor of the computer device 110 executes the command using the command executor module 120. The command executor module 120 transmits a request to each target 140a-140d, where the request includes a script associated with the single command 150a. The script may be different for each target in the case, for example, where different operating systems (e.g., Windows, Linux, etc.) are running on the targets. As such, the command executor module 120 can automatically adjust the transmitted request (e.g., by updated the program code in the script) depending on the relevant operating system without the need for user input. When the request, including the script, is received by the targets 140a-140d, the script can be executed simultaneously across each target in the distributed computing network. In the case of the example “find” command, the generated output can provide an indication about whether a particular file exists at each target along with the corresponding file path.

The script can include an instruction that transmits each generated output from each target back to the command executor module 120. The command executor module 120 can then perform a normalization of the generated outputs. In some instances, for example, the output generated from each target 140a-140d may not be in a common format. In the case where a target is running on a Linux operating system, the result may be a plain text format generated output, and in the case where a target is running on a Windows operating system, the result may be in a structured format. As such, the command executor module 120 can receive all the generated outputs from each target 140a-140d and normalize the results by converting each generated output into a JavaScript Object Notation (JSON) format. The JSON format of the results may then be transmitted to the application user interface 130 where a user can view the results in the application user interface 130 or download the results in a .csv format (e.g., using a separate spreadsheet application). In this way, the techniques described herein and illustrated by FIG. 1, provide an efficient way to run multiple commands against multiple computing systems in a distributed computing environment and gather the results in an easy to interpret manner for analytics purposes.

As described throughout the present disclosure, in an enterprise setting, there may be hundreds or thousands of computing systems distributed across a distributed computing network. The techniques described by the present disclosure simplify the task of performing maintenance and monitoring tasks across the distributed computing environment by saving computational resources. Performing a command, such as a versioning command on a set of thousands of targets, typically involves a user remotely accessing each individual target, executing the command, and gathering the results. This manual process can take days, weeks, or even months. This is a computationally intensive and time intensive process, and in the case where a problem has been identified, spending weeks to identify all impacted targets is not feasible. As such, the computing environment illustrated in FIG. 1, and described by the present disclosure allow for a grouping of commands (e.g., commands 150a-150d) and simultaneous execution across any number of selected targets (e.g., targets 140a-140d). This saves computational resources as results are gathered in a more accurate and more efficient manner (e.g., rather than a user individually accessing each target).

As mentioned previously, application user interface 130 of FIG. 1 is shown with four sample commands but any number of commands is possible for a user to select. The types of commands can vary depending on the particular task. Various non-limiting types of commands may include: determining software versions installed on a target (e.g., “versioning”), determining what processes are installed and running on a particular target (e.g., a real-time determination of what processes are installed and running), determining the most computationally intensive processes running on a particular target, querying a storage of a drive or storage location of a particular target, and identifying instances of drift (e.g., performing a matching to confirm that a particular configuration file is identical across all targets for a particular application install, for example). These examples are not intended to limit the present disclosure. One of ordinary skill in the art would recognize many variations, modifications, and alternatives.

FIG. 2 is a block diagram illustration of an example application user interface 130 and sample command, according to one or more aspects of the present disclosure. Application user interface 130 includes many of the same elements and features described above in relation to computing environment 100 of FIG. 1. The similar features in FIG. 2 therefore may share description as the corresponding feature described above in relation to FIG. 1, and as a result, the description references prior discussion of similar functionality.

As shown in FIG. 2, the application user interface 130 can include various features and functionality that a user may interact with to perform the techniques described by the present disclosure. One particular feature that a user may interact with is a “Commands” tab of the application user interface 130. FIG. 2 shows the Commands tab highlighted (e.g., shaded) to indicate that a user is interacting with this portion of the command executor module 120 that is running in the background. When the Commands tab is selected, a number of predefined commands appear on the application user interface 130 that a user can select from to perform a certain task. As shown in FIG. 2, application user interface 130 includes various sample predefined commands such as Drift (Windows) 210, Drift (Linux) 212, Find (Windows) 214, and Find (Linux) 216. Although only four sample commands are illustrated, any number of predefined commands are possible for the user to select from. Additionally, the commands are predefined in that the user only need to select the predefined commands, specify the targets, and then execute the command to obtain the generated output.

Also included in the Commands window of the application user interface 130 is a search bar where a user may search by a command name or particular operating system and the application user interface 130 will display results of the search. As described in relation to FIG. 1, this search feature can also be dynamic and provide an interface to assist a user in selected an appropriate command for their particular task. For example, rather than require a user to search using the specific technical language of the command (e.g., “Drift (Windows) 210”), a user can input into the search bar “help me determine if a configuration file is similar across targets” and the application user interface 130 will infer that performing a “Drift” command will accomplish this result. As such, examples of the present disclosure lower the required technical expertise needed by users to interface with the techniques described herein.

Staying with FIG. 2, Find Command 214 has been expanded to show the various arguments 250 included within the command. Although the commands are described as being predefined above, there may be instances where a user needs to modify the arguments 250 of the particular command for their specific purpose or use case. In this instance, a user is able to open up the predefined command and modify the arguments 250 as needed. As shown in FIG. 2, the various arguments 250 that may be adjusted by a user include specifying a target list, a directory path, modifying various options such as age, size, and pattern, flagging the output generated by executing of the command, and tagging the generated output. In some examples, age can refer to the age of the file (e.g., age is equal to, greater or less than the specific time). In some examples, a user can choose seconds, minutes, hours, days, or weeks to adjust the age and can specify the timing using the first letter of any of those words (e.g., “1 w” for one week). In some examples, size can refer to the size in bytes of the file. In some examples, pattern can refer to the file name of the files of interest. One of ordinary skill in the art would recognize many variations, modifications, and alternatives.

Also included in the exploded version of the find command 214 can be a help box. In some examples, the help box can be coupled to a recommender engine of the command executor module 120 to dynamically provide recommendations to a user as they modify or adjust the arguments 250 of the find command 214. In other words, as a user is entering modifications, a help tab displayed on the application user interface 130 can provide descriptions to the user to explain the functionality of the various arguments 250 and in some cases, the help tab can recommend other commands that may be of interest to the user.

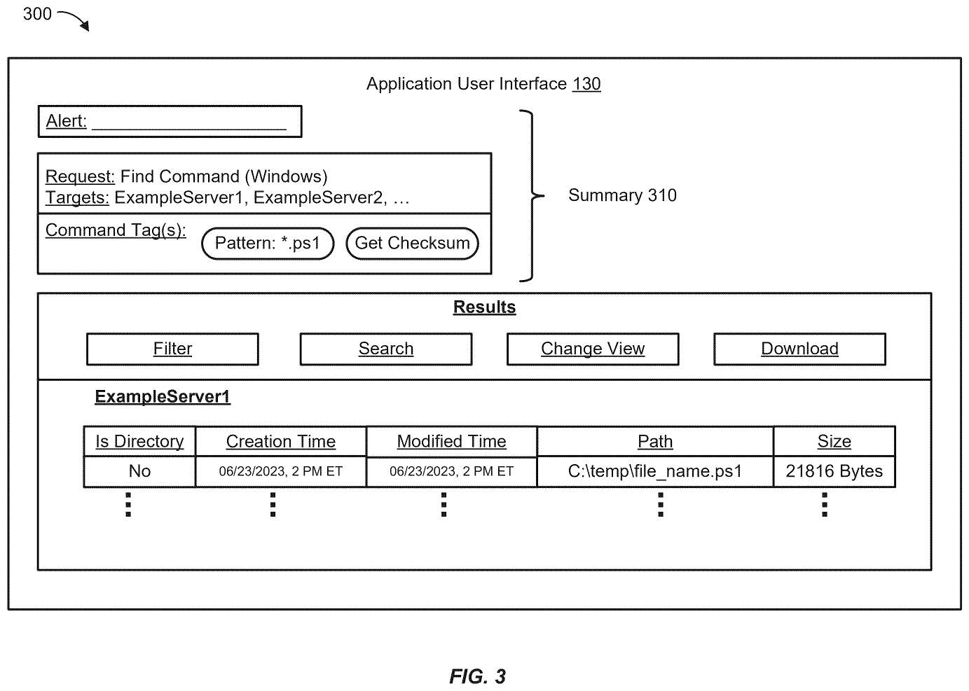

FIG. 3 is a block diagram illustrating an example 300 application user interface 130 displaying a generated output, according to one or more aspects of the present disclosure. As shown in the top portion of the application user interface 130 of FIG. 3, a summary 310 of the generated output is displayed. The summary 310 can include various data about the executed command to assist the user in better understanding the generated output. For example, the summary 310 can include an alert status bar. The alert status bar can display an indication of a failure at one or more of the targets during execution of the script associated with the command. In some examples, the command executor module 120 can determine a failure at a target when the time for executing the script exceeds a predetermined threshold. In response to the time exceeding a predetermined threshold, the command executor can receive an indication of a failure at the target and generate for display on the application user interface 130. Additionally, and although not shown in FIG. 3, in some examples, and in response to receiving an indication of a failure, the command executor module 120 can dynamically modify the script associated with the command for the target that failed thereby generating a modified script. This modified script may then be transmitted back to and re-executed on the target that failed.

As shown in FIG. 3, application user interface 130 also includes other elements included in the summary 310. For example, the summary 310 can include a brief description of the request (e.g., “Find Command (Windows)”) and the summary 310 can display the list of targets selected. Furthermore, the summary 310 can include a list of the command tags applied on the command (e.g., the tags described in relation to the arguments 250 discussed in relation to FIG. 2). In the example 300 of FIG. 3, the tags include a pattern of “.psl” and a Get Checksum tag. The pattern tag indicates that the Find Command is searching for all files with a “.psl” file type and the Get Checksum tag indicates that command was modified to extract the Checksum value for each file type of “.psl.”

Staying with FIG. 3, the generated output produced by executing the command across the targets is displayed on the application user interface 130 in the Results window. As shown in FIG. 3, the generated output for each target (e.g., “ExampleServer1,” “ExampleServer2,” etc.) may be display with the various data associated with the command. Staying with the Find Command (Windows) example discussed above, the generated output includes various pieces of data associated with the command such as whether the file is in a directory, the creation time of the file, the modification time of the file, the file path, and the size of the file. The results may also be filtered (e.g., filtered by target, creation time, modified time, directory, etc.) or the results may be searched through by using the filter and search features illustrated in the results window of the application user interface 130. Additionally, the results window provides various options for changing the view of the results (e.g., to a grid view, list view, table view, etc.) or downloading the results (e.g., downloaded to a .csv file).

The application user interface 130 and the results of the generated output as illustrated in FIG. 3 highlight an important advantage of the present disclosure. As one of ordinary skill in the art will appreciate, the unified result produced as a result of executing a command across one or more target computing systems of a distributed computing network improves upon the technical field of routine maintenance and monitoring of computing systems in an enterprise setting. The techniques provided by the present disclosure improve upon conventional techniques that require individual access to each target and manual organization of outputs. As shown in FIG. 3, the generated outputs are displayed in a user-friendly manner that quickly displays the results for any number of targets selected by the user. This data can easily be downloaded by the user for further analysis, or the commands can be adjusted as needed and re-executed across the targets. Accordingly, maintenance and monitoring that conventionally would take days, weeks, months, or not be possible, can now be performed in a matter of minutes.

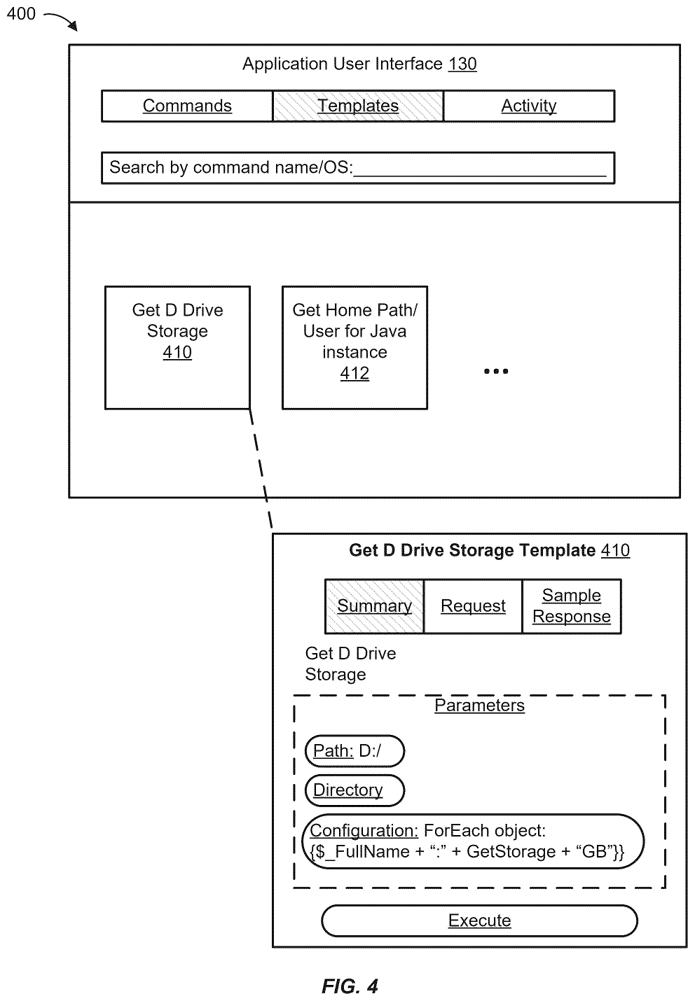

FIG. 4 is a block diagram illustrating an example 400 of an application user interface 130 and sample template (e.g., Get D Drive Storage Template 410), according to one or more aspects of the present disclosure. Application user interface 130 includes many of the same elements and features described above in relation to FIGS. 1-3. The similar features in FIG. 4 therefore may share description as the corresponding feature described above in relation to FIGS. 1-3, and as a result, the description references prior discussion of similar functionality. For instance, the search bar illustrated in FIG. 4, shares the same description as the search bar described in relation to FIG. 2.

FIG. 4 shows the Templates tab highlighted (e.g., shaded) to indicate that a user is interacting with the templates portion of the command executor module 120. When the Templates tab is selected, a number of predefined templates for commands appear on the application user interface 130 that a user can select from to perform a certain task. As shown in FIG. 4, application user interface 130 includes various sample predefined templates for commands such as Get D Drive Storage Template 410 and Get Home Path/User for Java Instance 412. Although only two sample predefined templates for commands are illustrated, any number of predefined templates for commands are possible for the user to select from. One of ordinary skill in the art would recognize many variations, modifications, and alternatives.

A predefined template for a command is a higher-level abstraction of a command that may be agnostic to the underlying operating system of a target computing system. For instance, as illustrated in FIG. 4, a predefined template for a command may involve a determination about D drive storage for a set of targets that comprise multiple operating systems (e.g., Windows and Linux). As illustrated by the exploded view of the Get D Drive Storage Temple 410, included in the predefined template for a command can be a fully executed command with a name, description, set of parameters, options, and flags. As shown in FIG. 4, the Summary tab of the exploded view is highlighted and displays a summary of the predefined template for a command. The application user interface 130 can also display the request (e.g., the script associated with the command) and a sample response that would be part of the generated output when executed. Additionally, as one of ordinary skill in the art will appreciate, the expertise level needed to formulate the predefined template for a command (e.g., Get D Drive Storage Temple 410) is higher. That is because formulating the appropriate configuration (e.g., Configuration displayed in the Summary of the Get D Drive Storage Temple 410) requires a certain level of expertise. By providing these templates with all arguments filled out, a user of any skill level can execute commands across targets.

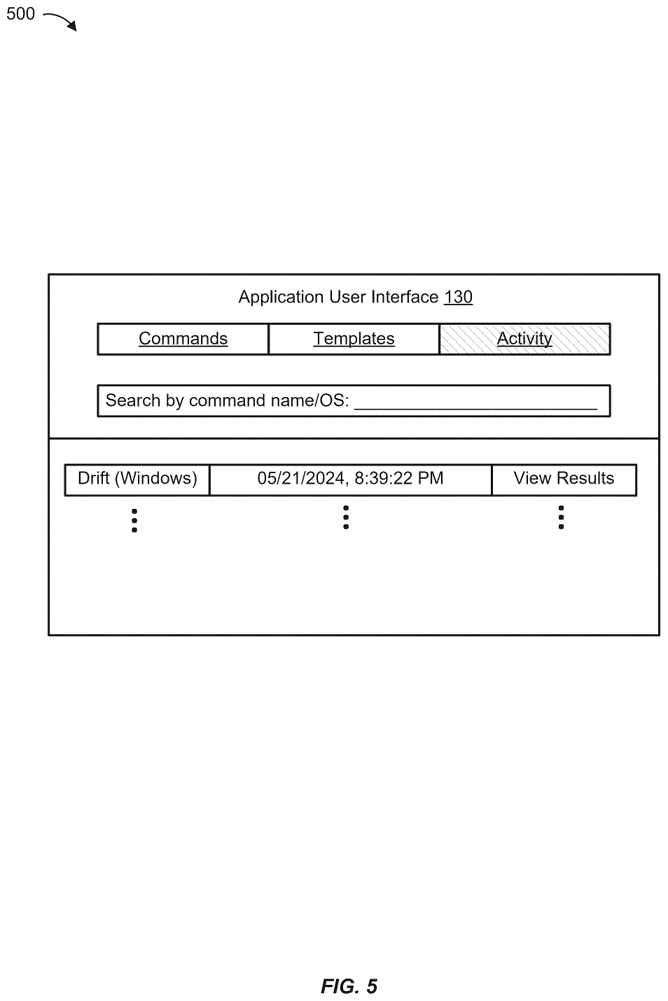

FIG. 5 is a block diagram illustrating an example 500 of an application user interface 130 and activity panel, according to one or more aspects of the present disclosure. Application user interface 130 includes many of the same elements and features described above in relation to FIGS. 1-4. The similar features in FIG. 5 therefore may share description as the corresponding feature described above in relation to FIGS. 1-5, and as a result, the description references prior discussion of similar functionality.

As shown in FIG. 5, the application user interface 130 may also include an activity panel. This is illustrated in FIG. 5 by the shading applied to the Activity tab of the application user interface 130. When the Activity tab is selected, a list of previous commands that have been executed by the user or other users is displayed on the application user interface 130. As shown in FIG. 5, the Activity tab displays a previously executed Drift (Windows) command that was executed on a particular date and time. Also included in the Activity tab is a view results feature. The view results feature displays the results from the previous executions of the command. In this way, examples of the present disclosure save computation resources because multiple users have access to the generated outputs without having to re-execute the commands. Rather, a user can simply access the activity tab and extract (e.g., download) the generated outputs.

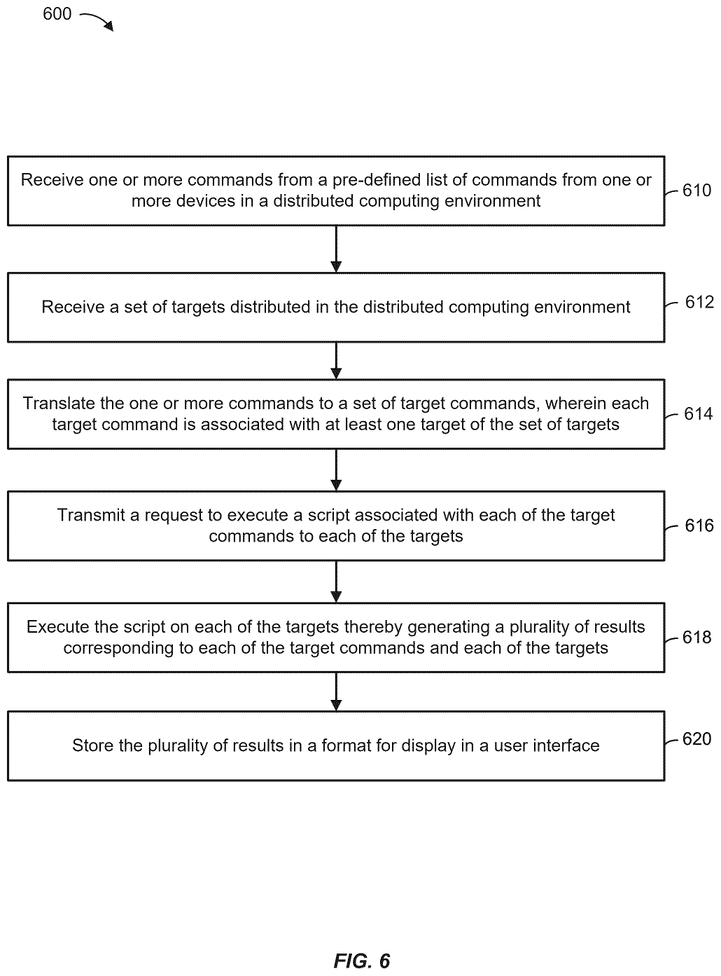

FIG. 6 is a flowchart of an example of a process 600 for executing commands and scripts across operating systems, according to one or more aspects of the present disclosure. The steps illustrated by process 600 may be performed, for example, by one or more processors of a computing device operating as a separate system or integrated with an application user interface, such as application user interface 130 described in relation to FIGS. 1-5. For the sake of simplicity, the steps illustrated in process 600 and described below, are described in relation to being performed by a processor, although variations and other configurations are possible.

As illustrated, process 600 may begin at block 610 in which a processor can receive one or more commands from a predefined list of commands from one or more devices in a distributed computing environment. The predefined list of commands can be configured to include all the appropriate arguments needed to properly execute the command on the selected targets. As such, the user need not be concerned with properly configuring the command. Instead, the user can focus on the high-level task they are trying to accomplish with the command. As described herein, the predefined commands can be associated tasks involving routine maintenance and monitoring of computing systems in a distributed computing network. Various non-limiting types of commands may include versioning, determining installed and running processes on a particular target, analyzing the most computationally intensive processes, storage querying, and identifying instances of drift. One of ordinary skill in the art would recognize many variations, modifications, and alternatives.

At block 612, the processor can receive a set of targets distributed in the distributed computing environment. As described herein, in an enterprise setting, an enterprise may control hundreds or thousands of computing systems across a distributed computing network, depending on the size and capabilities of the enterprise. Individually accessing each target computing system and executing the command on each target can take days, weeks, or even months. In some instances, given the scope of the targets, it may be impossible to execute commands and gather results for individual targets. As such, at block 612, the processor can receive a list of target computing systems of interest.

At block 614, the processor can translate the one or more commands to a set of target commands, wherein each target command is associated with at least one target of the set of targets. The target commands can include separate payloads for each target. Additionally, the target commands can be automatically configured by the processor such that the selected predefined command is agnostic to the underlying configuration of the target. For example, if a predefined command is selected to determine a storage capacity available on a drive of a target computing system, but the selected targets have different underlying operating systems (e.g., Windows, Linux, etc.), the processor can properly configure each target command for the appropriate operating system without the need for additional input.

At block 616, the processor can transmit a request to execute the script on each of the targets thereby generating a plurality of results corresponding to each of the target commands and each of the targets. Each target command has a separate payload and configuration. The target command includes a script that is configured to execute the command on the target. In some examples, when the processor transmits the request to execute the script, the processor can determine a predetermined time that the script should be executed within. In the case where the time for executing the script exceeds the predetermined threshold, a failure at the target can be identified. The processor can receive an indication of a failure at the target and generate for display on the application user interface. In response to the failure, the processor can dynamically modify the script associated with the target command for the target that failed thereby generating a modified script. This modified script may then be transmitted back to and re-executed on the target that failed.

At block 618, the processor can execute the script on each of the targets thereby generating a plurality of results corresponding to each of the target specific commands and each of the targets. Because each target command has a separate payload, each target command and associated script can be executed simultaneously across the one or more targets. The scripts may be executed and then return the generated output back to the processor for normalization and display on the user interface.

At block 620, the processor can store the plurality of results in a format for display in a user interface. As previously described, depending on the underlying operating systems of the targets, the generated output may not be in the same format across targets. As a result, the processor can receive the generated output and normalize the results for display in the user interface. For example, in the case where a target is running on a Linux operating system, the generated output may be a plain text format generated output, and in the case where a target is running on a Windows operating system, the generated output may be in a structured format. The processor can receive these results and normalize the results by converting each generated output into a JSON format. The JSON format of the results may then be transmitted to the user interface for viewing and/or downloading.

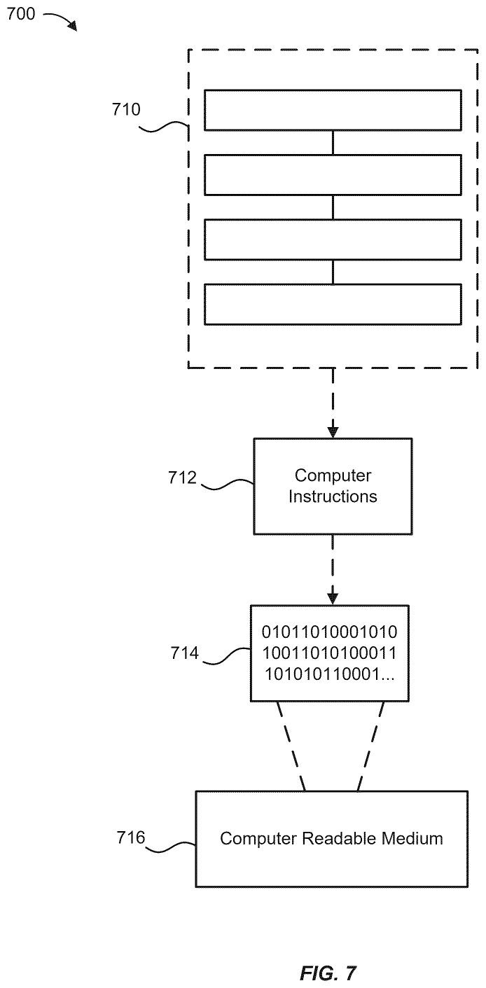

One or more of the aspects of the present disclosure include a computer-readable medium including microprocessor or processor-executable instructions configured to implement one or more embodiments presented herein. FIG. 7 is a block diagram illustrating an example computer-readable medium or computer-readable device including processor-executable instructions configured to embody one or more of the aspects set forth herein. As illustrated in FIG. 7, implementation 700 includes a computer-readable medium 716. Computer-readable medium 716 can include a CD-R, DVD-R, flash drive, a platter of a hard disk drive, and so forth, on which computer-readable data 714 is encoded and stored. The computer-readable data 714, such as binary data including a plurality of zero's and one's as illustrated, in turn includes a set of computer instructions 712 configured to operate according to one or more of the principles set forth herein.

In the illustrated implementation 700 of FIG. 7, the set of computer instructions 712 (e.g., processor-executable computer instructions) may be configured to perform a method 710, such as the process 600 of FIG. 6, for example. In another embodiment, the set of computer instructions 712 may be configured to implement a system, such as the computing environment 100 of FIG. 1, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

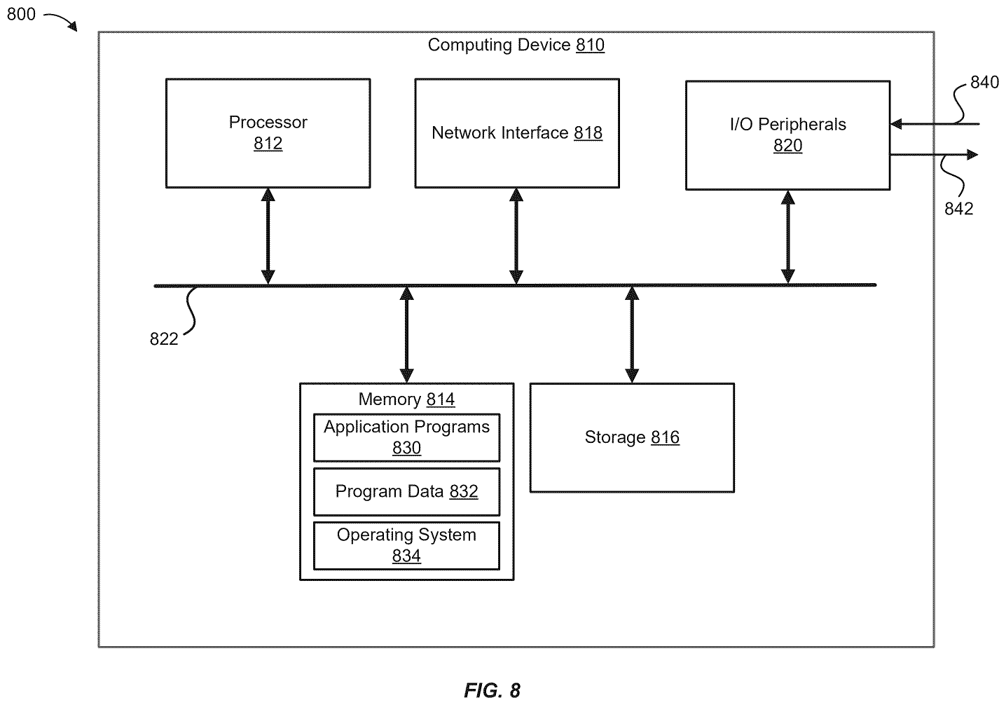

FIG. 8 and the following discussion provide a description of a suitable computing environment 800 to implement embodiments of one or more of the aspects set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 8 is a block diagram illustrating an example computing environment 800 for implementing a command executor module, according to one or more aspects of the present disclosure. In one configuration, the computing device 810 may include at least one processor 812 and at least one memory 814. Depending on the exact configuration and type of computing device, the at least one memory 814 may be volatile, such as RAM, non-volatile, such as ROM, flash memory, etc., or a combination thereof. Examples of processor 812 include a microprocessor, an application-specific integrated circuit (ASIC), a field-programmable gate array (FPGA), or any other suitable processing device. Computing device 810 can include one processor, such as is illustrated by processor 812 in FIG. 8, or more than one processor.

Computing device 810 may include additional features or functionality. For example, the computing device 810 may include storage such as removable storage or non-removable storage, including, but not limited to, magnetic storage, optical storage, etc. Such storage is illustrated in FIG. 8 by storage 816. In one or more embodiments, computer readable instructions to implement one or more embodiments provided herein are in the storage 816. The storage 816 may store other computer readable instructions to implement an operating system, an application program, etc. Computer readable instructions may be loaded in the at least one memory 814 for execution by the at least one processor 812, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 8, the computing environment 800 may also include a number of additional external or internal devices, for example, input or output devices. For example, computing device 810 is illustrated as including input/output (I/O) peripherals 820. I/O peripherals 820 can receive input 840 from an input device (not shown) or provide output 842 to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 810. I/O peripherals 820 may be connected to the computing device 810 via a wired connection, wireless connection, or any combination thereof. Further, the computing device 810 may include network interface 818 to facilitate communications with one or more other devices (not shown). Network interface 818 can include any device or group of devices suitable for establishing a wired or wireless data connection to one or more data networks. Non-limiting examples of the network interface 818 include an Ethernet network adaptor, a wireless network adapter, a modem, Wi-Fi adapter, Bluetooth adapter, near field communication (NFC) receiver and transmitter, and any other known wired or wireless data transmission system.

Computing device 810 also includes interface bus 822. Although only one interface bus is illustrated, computing environment 800 can include more than one interface bus. Interface bus 822 can communicatively couple one or more components of computing device 810.

Staying with FIG. 8, computing environment 800 includes one or more application programs 830 and/or program data 832 that may be accessible in memory 814 by the computing device 810. According to some implementations, the application programs 830 and/or program data 832 are included, at least in part, in the computing device 810. The application programs 830 may include an application to execute the operations described in relation to the command executor module 120 and is arranged to perform the functions as described herein including those described with respect to the computing environment 100 of FIG. 1 and/or the process 600 of FIG. 6. The program data 832 may include commands and/or command executor module information that may be useful for operation with the various aspects as described herein. Memory 814 also includes instructions for implementing an operating system 834 of computing device 810.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
receiving one or more commands from a predefined list of commands from one or more devices in a distributed computing environment;
receiving a set of targets distributed in the distributed computing environment;
translating the one or more commands to a set of target commands, wherein each target command is associated with at least one target of the set of targets;
transmitting a request to execute a script associated with each of the target commands to each of the targets;
executing the script on each of the targets thereby generating a plurality of results corresponding to each of the target commands and each of the targets; and
storing the plurality of results in a format for display in a user interface.

2. The method of claim 1, wherein the set of targets comprises:
a first target having a first operating system;
a second target having a second operating system that is different from the first operating system; and
wherein the script associated with each of the target commands comprises a first script operable to execute the target command on the first target and a second script operable to execute the target command on the second target.

3. The method of claim 1, further comprising:
transmitting a timestamp to the set of target commands executed on the each of the targets;
receiving an indication of a failure at one or more of the targets during execution of the script;
generating, in response to receiving an indication of the failure, an alert of the failure for display on the user interface;
modifying, in response to receiving the alert, the script associated with the target command thereby generating a modified script;
transmitting a second request to one or more of the targets to execute the modified script; and
executing the modified script on the one or more targets.

4. The method of claim 3, wherein the failure is detected when a time for executing the script exceeds a predefined threshold as compared to the timestamp.

5. The method of claim 1, wherein the format for display comprises a table comprising a plurality of rows and each row displays one of the results of the plurality of results and wherein each row corresponds to a particular target.

6. The method of claim 1, wherein execution of the script on each of the targets occurs simultaneously.

7. The method of claim 1, wherein the plurality of results comprises at least one of a determination of a software version implemented on a target, a list of processes running on a target, a list software programs installed on a target, a determination of a top consuming computing resource on a target, a memory capacity of a target, a list of program data located in a folder of a target, and a determination of whether a particular configuration file is used across the set of targets.

8. A system for executing commands in a distributed computing environment, the system comprising:
one or more processors;
a memory coupled to the one or more processors, the memory including instructions that, when executed by the one or more processors, cause the one or more processors to:
receive one or more commands from a predefined list of commands from one or more devices in the distributed computing environment;
receive a set of targets distributed in the distributed computing environment;
translate the one or more commands to a set of target commands, wherein each target command is associated with at least one target of the set of targets;
transmit a request to execute a script associated with each of the target commands to each of the targets;
execute the script on each of the targets thereby generating a plurality of results corresponding to each of the target commands and each of the targets; and
store the plurality of results in a format for display in a user interface.

9. The system of claim 8, wherein the set of targets comprises:
a first target having a first operating system;
a second target having a second operating system that is different from the first operating system; and
wherein the script associated with each of the target commands comprises a first script operable to execute the target command on the first target and a second script operable to execute the target command on the second target.

10. The system of claim 8, wherein the instructions further cause the one or more processors to:
transmit a timestamp to the set of target commands executed on the each of the targets;
receive an indication of a failure at one or more of the targets during execution of the script;
generate, in response to receiving an indication of the failure, an alert of the failure for display on the user interface;
modify, in response to receiving the alert, the script associated with the target command thereby generating a modified script;
transmit a second request to one or more of the targets to execute the modified script; and
execute the modified script on the one or more targets.

11. The system of claim 10, wherein the failure is detected when a time for executing the script exceeds a predefined threshold as compared to the timestamp.

12. The system of claim 8, wherein the format for display comprises a table comprising a plurality of rows and each row displays one of the results of the plurality of results and wherein each row corresponds to a particular target.

13. The system of claim 8, wherein execution of the script on each of the targets occurs simultaneously.

14. The system of claim 8, wherein the plurality of results comprises at least one of a determination of a software version implemented on a target, a list of processes running on a target, a list software programs installed on a target, a determination of a top consuming computing resource on a target, a memory capacity of a target, a list of program data located in a folder of a target, and a determination of whether a particular configuration file is used across the set of target.

15. A non-transitory computer-readable medium embodying program code that, when executed by one or more processors, causes the one or more processors to perform operations comprising:
receive one or more commands from a predefined list of commands from one or more devices in a distributed computing environment;
receive a set of targets distributed in the distributed computing environment;
translate the one or more commands to a set of target commands, wherein each target command is associated with at least one target of the set of targets;
transmit a request to execute a script associated with each of the target commands to each of the targets;
execute the script on each of the targets thereby generating a plurality of results corresponding to each of the target commands and each of the targets; and
store the plurality of results in a format for display in a user interface.

16. The non-transitory computer-readable medium of claim 15, wherein the set of targets comprises:
a first target having a first operating system;
a second target having a second operating system that is different from the first operating system; and
wherein the script associated with each of the target commands comprises a first script operable to execute the target command on the first target and a second script operable to execute the target command on the second target.

17. The non-transitory computer-readable medium of claim 15, further comprising program code that is executable by the one or more processors to cause the one or more processors to:
transmit a timestamp to the set of target commands executed on the each of the targets;
receive an indication of a failure at one or more of the targets during execution of the script;
generate, in response to receiving an indication of the failure, an alert of the failure for display on the user interface;
modify, in response to receiving the alert, the script associated with the target command thereby generating a modified script;
transmit a second request to one or more of the targets to execute the modified script; and
execute the modified script on the one or more targets.

18. The non-transitory computer-readable medium of claim 15, wherein the format for display comprises a table comprising a plurality of rows and each row displays one of the results of the plurality of results and wherein each row corresponds to a particular target.

19. The non-transitory computer-readable medium of claim 15, wherein execution of the script on each of the targets occurs simultaneously.

20. The non-transitory computer-readable medium of claim 15, wherein the plurality of results comprises at least one of a determination of a software version implemented on a target, a list of processes running on a target, a list software programs installed on a target, a determination of a top consuming computing resource on a target, a memory capacity of a target, a list of program data located in a folder of a target, and a determination of whether a particular configuration file is used across the set of targets.
